(19) United States
(12) Patent Application Publication
(10) Pub. No.: US 2026/0163303 A1
(43) Pub. Date: Jun. 11, 2026

(54) Electrical Connector and Electrical Connector Assembly

(71) Applicant: TE Connecitivity Japan G. K., Kawasaki-shi (JP)

(72) Inventors: Masaaki Saito, Kawasaki-shi (JP); Kosuke Maeba, Kawasaki-shi (JP)

(73) Assignee: TE Connecitivity Japan G. K., Kawasaki-shi (JP)

(21) Appl. No.: 19/181,501

(22) Filed: Apr. 17, 2025

(30) Foreign Application Priority Data
Apr. 19, 2024 (JP) 2024-067916

(51) Int. Cl. H01R 13/631; H01R 13/52; H01R 13/621

(52) U.S. Cl. CPC H01R 13/631; H01R 13/5219; H01R 13/621

(57) ABSTRACT

An electrical connector includes a housing and one of a plurality of bases assembled with the housing. The housing has a mating tube matable with a mating connector. Each of the plurality of bases has a locking element of one of a plurality of different locking types. The one of the plurality of bases is assembled with the housing with the mating tube penetrating through a front and a back of the one of the plurality of bases and protruding from the one of the plurality of bases. The locking element is fixable to the mating connector and is selectable among the plurality of different locking types to correspond to a fixing type of the mating connector.

### CROSS-REFERENCE TO RELATED APPLICATIONS

This application claims the benefit of the filing date under 35 U.S.C. § 119(a)-(d) of Japanese Patent Application No. 2024-067916, filed on Apr. 19, 2024.

### FIELD OF THE INVENTION

The present invention relates to an electrical connector and, more particularly, to an electrical connector that can cope with two different locking types.

### BACKGROUND OF THE INVENTION

A header connector for supplying external power to a motor such as a servo motor is installed on the motor. A receptacle connector connected to a cable is prevented from coming off the header connector by being mated with and fixed (locked) to the header connector, thereby constituting an electrical connector assembly that supplies power to the motor. There are typically two types of locking used to lock the receptacle connector and the header connector together (i.e., a one-touch type and a screw-tightening type).

Japanese Patent Application No. 2016-048654A, for example, is the one-touch type of locking. A connector assembly disclosed in JP2016-048654A includes a locking type for making locking members provided on both sides in a width direction of a receptacle connector and elastic locking members provided on both sides in a width direction of a header connector engage with each other.

Currently, a one-touch type electrical connector is mainly used, but there is also a demand for a screw-tightening type electrical connector. Since the one-touch type electrical connector and the screw-tightening type electrical connector differ in locking type, separate components need to be respectively prepared for the one-touch type and the screw-tightening type. However, a function as an electrical connector is common between the one-touch type and the screw-tightening type.

### SUMMARY OF THE INVENTION

An electrical connector includes a housing and one of a plurality of bases assembled with the housing. The housing has a mating tube matable with a mating connector. Each of the plurality of bases has a locking element of one of a plurality of different locking types. The one of the plurality of bases is assembled with the housing with the mating tube penetrating through a front and a back of the one of the plurality of bases and protruding from the one of the plurality of bases. The locking element is fixable to the mating connector and is selectable among the plurality of different locking types to correspond to a fixing type of the mating connector.

### BRIEF DESCRIPTION OF DRAWINGS

The invention will now be described by way of example with reference to the accompanying figures, of which:

FIG. 1A is an isometric view of a receptacle connector according to an exemplary embodiment;

FIG. 1B is an exploded view of the receptacle connector of FIG. 1A;

FIG. 1C is a contact housing of the receptacle connector of FIG. 1A;

FIG. 2A is an isometric view of a header connector according to an exemplary embodiment;

FIG. 2B is a header base of the header connector of FIG. 2A;

FIG. 2C is a seal of the header connector of FIG. 2A;

FIG. 2D is a header housing of the header connector of FIG. 2A;

FIG. 3A is a right side schematic view of an assembly of the receptacle connector of FIG. 1A and the header connector of FIG. 2A;

FIG. 3B is a top schematic view of the assembly of FIG. 3A;

FIG. 3C is a left side schematic view of the assembly of FIG. 3A;

FIG. 3D is a bottom schematic view of the assembly of FIG. 3A;

FIG. 4A is a rear schematic view of an assembly of the receptacle connector of FIG. 1A and the header connector of FIG. 2A;

FIG. 4B is a vertical sectional view of the view of FIG. 4A;

FIG. 5A is an isometric view of a receptacle connector according to another exemplary embodiment;

FIG. 5B is an exploded view of the receptacle connector of FIG. 5A;

FIG. 5C is a contact housing of the receptacle connector of FIG. 5A;

FIG. 6A is an isometric view of a header connector according to another exemplary embodiment;

FIG. 6B is a header base of the header connector of FIG. 6A;

FIG. 6C is a seal of the header connector of FIG. 6A;

FIG. 6D is a header housing of the header connector of FIG. 6A;

FIG. 7A is a right side schematic view of an assembly of the receptacle connector of FIG. 5A and the header connector of FIG. 6A;

FIG. 7B is a top schematic view of the assembly of FIG. 7A;

FIG. 7C is a left side schematic view of the assembly of FIG. 7A;

FIG. 7D is a bottom schematic view of the assembly of FIG. 7A;

FIG. 8A is a rear schematic view of an assembly of the receptacle connector of FIG. 5A and the header connector of FIG. 6A;

FIG. 8B is a vertical sectional view of the view of FIG. 8A; and

FIG. 9 is a diagram of assembling the header connector of FIG. 2A and the header connector of FIG. 6A.

### DETAILED DESCRIPTION

Exemplary embodiments will be described below with reference to the accompanying drawings.

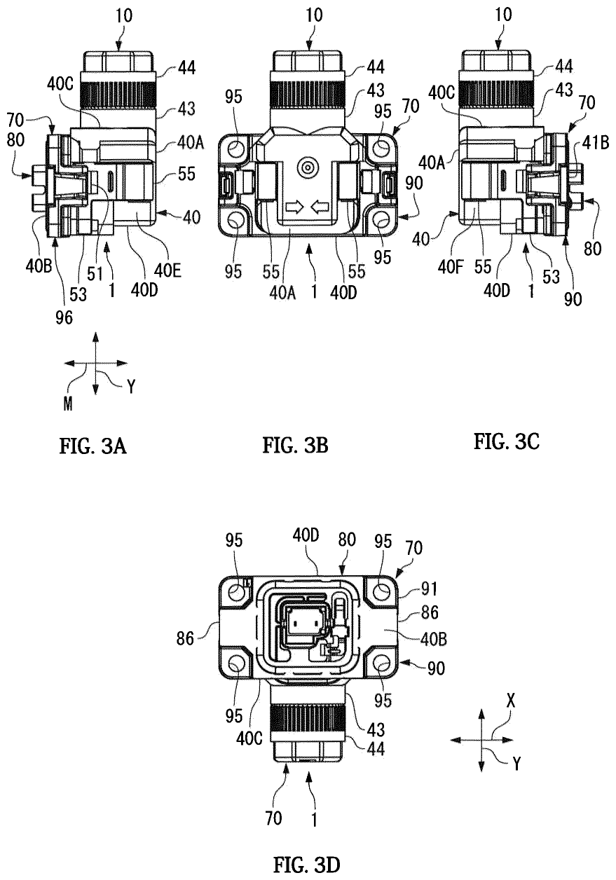

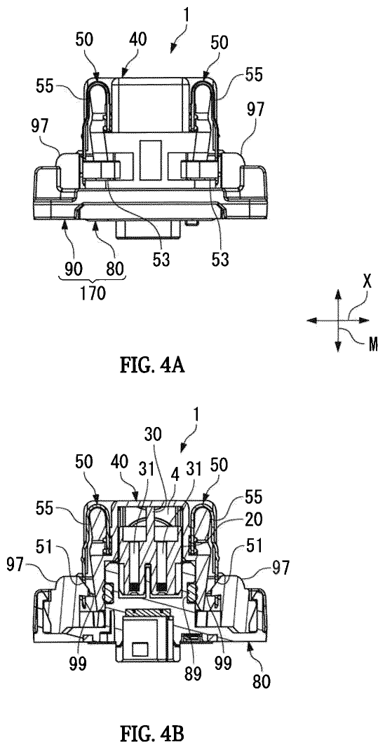

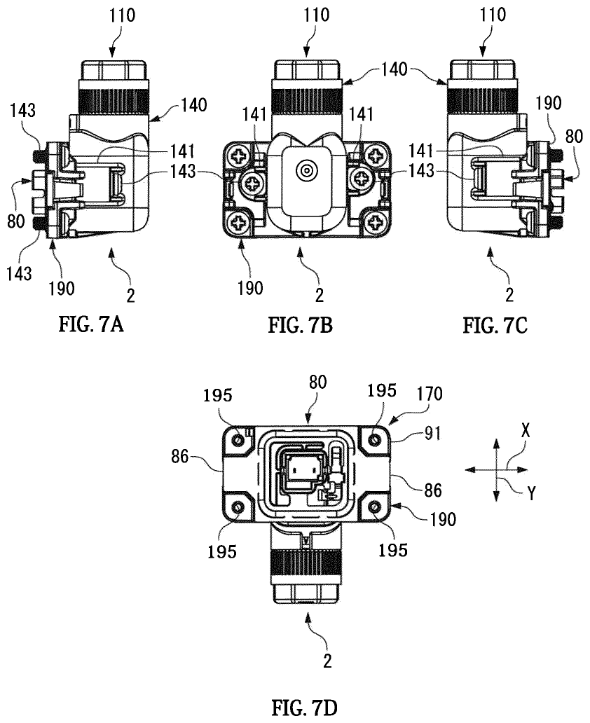

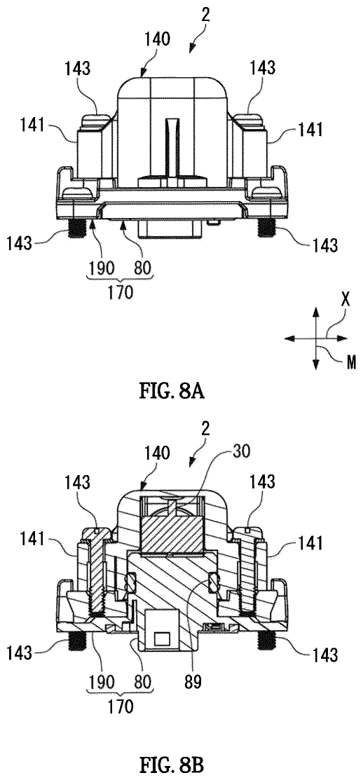

The embodiments include a one-touch type first connector assembly 1, as shown in FIGS. 3A-4B, and a screw-tightening type second connector assembly 2, as shown in FIGS. 7A-8B. Both connector assemblies 1, 2 are each configured by mating a header connector 70, 170 and a receptacle connector 10, 110 with each other. In an embodiment, the first connector assembly 1 is configured by mating a receptacle connector 10 and a header connector 70 with each other, and the second connector assembly 2 is configured by mating a receptacle connector 110 and a header connector 170 with each other. As used throughout the detailed description, the header connectors 70, 170 can also be referred to as an “electrical connector” and the receptacle connectors 10, 110 can also be referred to as a “mating connector”.

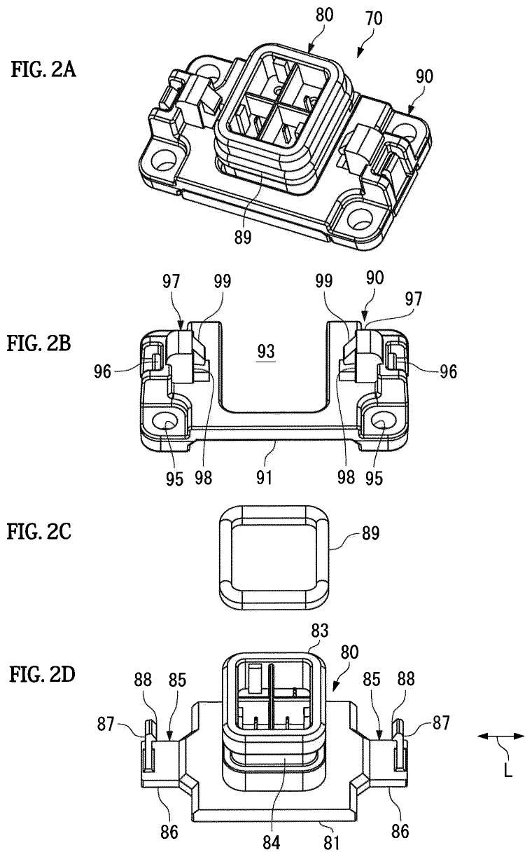

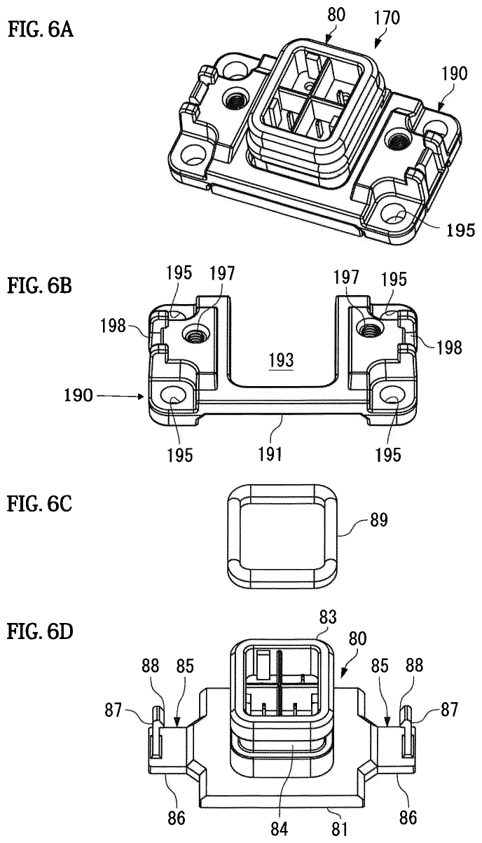

Some components are shared between the first connector assembly 1 and the second connector assembly 2. As shown in FIGS. 2 and 6, each header connector 70, 170 is divided into a portion having a structure that can be common to a one-touch type and a screw-tightening type and a portion having a structure that cannot be common thereto. That is, a portion associated with mating between the receptacle connector 10 and the header connector 70 and a portion associated with mating between the receptacle connector 110 and the header connector 170 are respectively common members, and a portion associated with fixing, i.e., locking between the receptacle connector 10 and the header connector 70 and a portion associated with locking between the receptacle connector 110 and the header connector 170 are respectively separate members. Consequently, each header connector 70, 170 is divided into two members to correspond to two functions (i.e., mating and locking), and the member that performs the mating function is shared for both header connectors 70, 170.

The one-touch type first connector assembly 1 and the screw-tightening type second connector assembly 2 will be described below in this order, and then sharing of the member will be described.

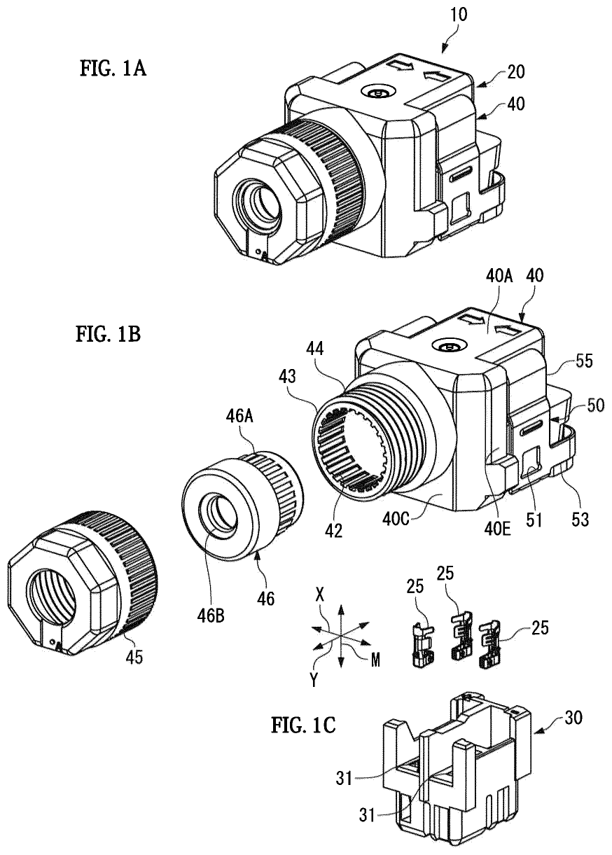

An exemplary embodiment of the first connector assembly 1 is now described with reference to FIGS. 1A-4B. As shown in FIGS. 1A and 3A-3C, the first connector assembly 1 comprises the receptacle connector 10 that terminates and connects a cable. The first connector assembly 1 also comprises the header connector 70, as shown in FIGS. 2A and 3A-3D, that is mated with and locked to the receptacle connector 10.

As shown in FIGS. 1A-1B and 4A-4B, the receptacle connector 10 includes a connector housing 20 and a pair of locking members 50. The connector housing 20 includes a contact housing 30, as shown in FIGS. 1C and 4B, and a base housing 40, as shown in FIGS. 1A-1B, 3A, 3C, and 4A-4B. The base housing 40 accommodates the contact housing 30. As used throughout the detailed description, the locking members 50 are a “fixing type” (i.e., a one-touch type) of the receptacle connector 10 of the present disclosure.

As shown in FIG. 1C, the contact housing 30 is formed in a substantially rectangular parallelepiped shape and includes a plurality of contact housing chambers 31 as, for example, two columns. The contact housing 30 is configured as a single member by, for example, injection molding of a resin material.

A receptacle contact 25 is caught in each of the contact housing chambers 31 in the contact housing 30 by, for example, a housing lance. The receptacle contacts 25 are respectively connected to electric wires included in the cable. Each of the receptacle contacts 25 is formed by stamping and forming an electrically conductive metal sheet. As shown in FIG. 1B, only three receptacle contacts 25 are illustrated as an example.

As shown in FIG. 1B, the base housing 40 is formed in a substantially rectangular parallelepiped shape extending in a mating direction indicated by an arrow M, a left-right direction indicated by an arrow X perpendicular to the mating direction, and a front-rear direction indicated by an arrow Y perpendicular to the mating direction and the left-right direction. The base housing 40 is configured as a single member by, for example, injection molding of a resin material.

As shown in FIGS. 1B and 3A-3D, the base housing 40 includes a top face 40A, a bottom face 40B, a front face 40C, a back face 40D, a right side face 40E, and a left side face 40F. The base housing 40 has a space formed therein. The space of the base housing 40 accommodates the contact housing 30. The space opens downward in the mating direction M of the base housing 40 and extends upward in the mating direction M of the base housing 40. The pair of locking members 50 is attached to the base housing 40.

As shown in FIG. 1B, on the front face 40C side of the base housing 40, a cable opening 42 for introducing a cable is formed, and a cable introduction tube 43 surrounding the cable opening 42 is formed to protrude forward. As further shown in FIG. 1B, a screw 44 is formed on the outer periphery of the cable introduction tube 43.

As shown in FIG. 1B, a waterproof rubber 46 has large-diameter portions and small-diameter portions and is cylindrical-shaped. The waterproof rubber 46 has a small-diameter part 46A inserted into the inner periphery side of the cable introduction tube 43. A screw formed on the inner periphery of a waterproof rubber tightening nut 45 engages with the screw 44 on the outer periphery side of the cable introduction tube 43. When the cable is attached, a distal end of the cable is introduced into the cable opening 42 through an inner through hole 46B in the waterproof rubber 46. The engagement of the waterproof rubber tightening nut 45 with the cable introduction tube 43 is advanced, so that the waterproof rubber 46 clamps the cable from the outer periphery side of the cable. This results in sealing between the waterproof rubber 46 and the cable.

As shown in FIGS. 4A-4B, the pair of locking members 50 are installed at both outer ends in the left-right direction X of the base housing 40. Each of the locking members 50 includes a locking piece 53 extending from the right side face 40E or the left side face 40F toward the back face 40D. Each of the locking members 50 also includes a locking piece 55 extending from the right side face 40E or the left side face 40F toward the top face 40A. The locking piece 53 is fixed to the base housing 40 on the back face 40D, and the locking piece 55 is fixed to the base housing 40 on the top face 40A, so that the locking member 50 is attached to the base housing 40. As shown in FIG. 4B, a connection portion between the locking piece 53 and the locking piece 55 has a locking hole 51 formed therein. The locking hole 51 penetrates through a front and a back of the connection portion. As further shown in FIG. 4B, a catch protrusion 99 in a header base 90 is inserted into the locking hole 51, so that the receptacle connector 10 and the header connector 70 are locked together.

As shown in FIG. 2A, the header connector 70 includes a header housing 80 and the header base 90 supported on the header housing 80. The header connector 70 retains a plurality of header contacts. The header housing 80 is shared with the second connector assembly 2. In other words, the header connector 170 of the second connector assembly 2 also has the header housing 80.

As shown in FIG. 2D, the header housing 80 includes a housing base 81, a mating tube 83 formed to protrude from a front surface of the housing base 81, and elastic locking parts 85 provided on both sides in a longitudinal direction (L) of the housing base 81. The housing base 81 supports the header base 90 and has a rectangular shape in a planar view. The header housing 80, the housing base 81, the mating tube 83, and the elastic locking parts 85 are formed as a single member by, for example, injection molding of a resin material.

As shown in FIG. 2D, the mating tube 83 has a square cylindrical-shaped form. In other words, the mating tube 83 has a cylindrical square shape. As shown in FIG. 4B, the contact housing 30 in the receptacle connector 10 is accommodated inside the mating tube 83. As further shown in FIG. 2D, the elastic locking parts 85 respectively include supports 86 extending from both sides in the longitudinal direction (L) of the housing base 81, elastic arms 87 that rise from the supports 86, and locking protrusions 88 of the elastic arms 87. The locking protrusions 88 protrude toward the mating tube 83. The elastic arms 87 in the elastic locking parts 85 are respectively caught in locking claws 96 in the header base 90 when the header housing 80 and the header base 90 are assembled, so that the header housing 80 and the header base 90 are locked together.

As shown in FIG. 2D, a rubber seal annular groove 84 is formed on the outer periphery of the mating tube 83. A seal 89, as shown in FIG. 2C, positioned in the rubber seal annular groove 84 has an annular shape and is made of rubber. The seal 89 seals an area between the mating tube 83 and the base housing 40. Although the seal 89 having one sealing protrusion on its outer periphery is depicted in FIG. 2C, the seal 89 may, for example, have two sealing protrusions as illustrated in FIG. 4B, to obtain a higher waterproof performance. As shown in FIG. 4B, in the case of the example of the seal 89 having two sealing protrusions, the sealing protrusion as a sealing element is doubled in the mating direction M, and an annular seal can also be positioned on a lower surface of the housing base 81. One (a single) sealing protrusion may be provided, or a plurality of (three or more) sealing protrusions may be provided.

As shown in FIG. 2B, the header base 90 includes a base 91, a mating tube space 93 in which the mating tube 83 is positioned by penetrating therethrough, and screw through holes 95 respectively formed in four corners of the base 91. The base 91 includes the locking claws 96 for mutual locking to the header housing 80 and locking parts 97 for mutual locking to the base housing 40 in the receptacle connector 10. The locking claws 96 are respectively mutually caught in the locking protrusions 88 in the header housing 80. As shown in FIG. 2B, each of the locking parts 97 includes a support 98 that rises (e.g., extends) from the base 91 and a catch protrusion 99. The catch protrusions 99 protrude toward the mating tube 83 on the upper end side of the support 98 and are respectively inserted into the locking holes 51 in the locking member 50 provided in the base housing 40, thereby performing locking between the receptacle connector 10 and the header connector 70. As used throughout the detailed description, the locking parts 97 are a “locking type” (i.e., a one-touch type) of a “locking element” of the header connector 70 of the present disclosure.

The header base 90 is configured as a single member by, for example, die-casting an aluminum alloy. If the header base 90 is made of a metal material, the header base 90 can be produced by not only the die-casting but also other metal working methods such as cutting and a layered manufacturing method. The header base 90 can be composed of not only the metal material but also a material, having a strength with which a shape of the header base 90, as shown in FIG. 2B, can be kept, such as a resin material. If the header base 90 is composed of the resin material, the header base 90 can be produced by injection molding.

The header base 90 is fixed to a housing of a motor, with the receptacle connector 10 mounted on the header housing 80. This fixing is performed by tightening screws to the housing of the motor after respectively penetrating through the four screw through holes 95. At this time, the mating of the receptacle connector 10 with the header connector 70 is performed between the base housing 40 and the header housing 80, the locking of the receptacle connector 10 to the header connector 70 is performed between the base housing 40 and the header base 90, and the fixing of the first connector assembly 1 to the motor is performed through the header base 90. That is, in the first connector assembly 1, the header connector 70 is divided into two, i.e., the header housing 80 and the header base 90 depending on functions such that the header housing 80 is made to have a function of the mating with the receptacle connector 10, and the header base 90 is made to have a function of the fixing to the motor.

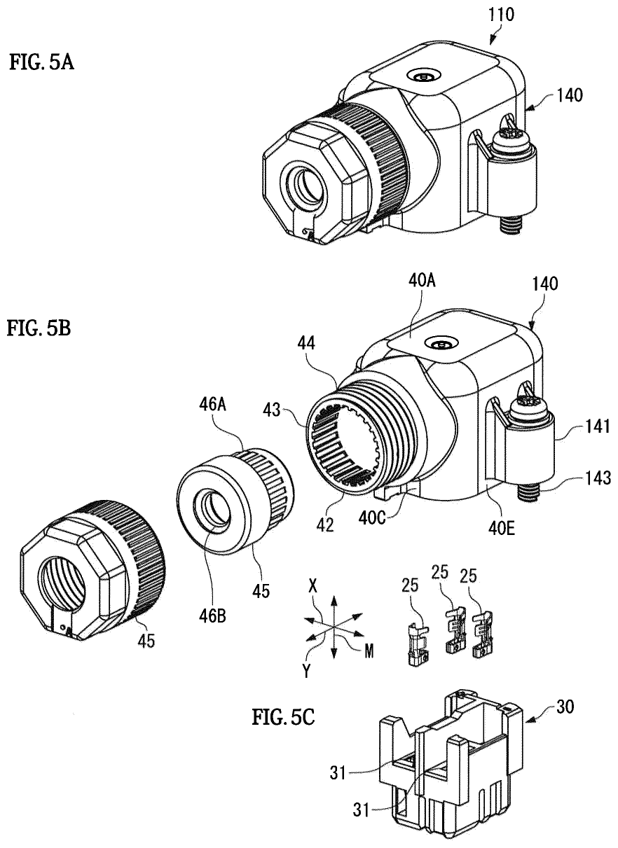

An exemplary embodiment of the second connector assembly 2 is now described with reference to FIGS. 5A-8B. As shown in FIGS. 5A and 7A-7C, the second connector assembly 2 comprises the receptacle connector 110 that terminates and connects a cable. The second connector assembly 2 also comprises the header connector 170, as shown in FIGS. 6A and 7D, that is mated with and locked to the receptacle connector 110. In the below description of the second connector assembly 2, differences between the second connector assembly 2 and the first connector assembly 1 will be mainly described. Description of the same elements as those in the first connector assembly 1 may be omitted by respectively assigning the elements the same reference numerals as those in the first connector assembly 1.

As shown in FIGS. 5A-5C, 7A-7C, and 8A-8B, the receptacle connector 110 includes a base housing 140 and a contact housing 30. As shown in FIG. 8B, the base housing 140 accommodates the contact housing 30. The contact housing 30 has the same configuration as that of the contact housing 30, as shown in FIGS. 1C and 4B, of the first connector assembly 1, and hence description thereof is omitted here.

As shown in FIGS. 5A and 8A-8B, the base housing 140 has screw holders 141 respectively provided on both a right side face 40E and a left side face 40F. As shown in FIGS. 5B and 8A-8B, the screw holders 141 respectively retain fixing screws 143 along the mating direction M. The fixing screws 143 penetrate through the screw holders 141. Each of the fixing screws 143 has its head portion exposed from an upper end of the screw holder 141 and its shaft portion exposed from a lower end of the screw holder 141 on the distal end side. The shaft portion exposed from the screw holder 141 engages with a screw hole 197 in the header base 190 described below. As used throughout the detailed description, the screw holes 197 are a “locking type” (i.e., a screw-tightening type) of the “locking element” of the header connector 170 of the present disclosure. As used throughout the detailed description, the screw holders 141 are a “fixing type” (i.e., a screw-tightening type) of the receptacle connector 110 of the present disclosure.

As shown in FIG. 5B, the base housing 140 includes a cable opening 42, a cable introduction tube 43, a waterproof rubber tightening nut 45, and waterproof rubber 46, like the base housing 40.

As shown in FIG. 6A, the header connector 170 includes a header housing 80 and the header base 190 supported on the header housing 80. The header housing 80 retains a plurality of header contacts. The header housing 80 is shared with the first connector assembly 1. In other words, as described above, the header connector 70 of the first connector assembly 1 has the header housing 80. The header housing 80 has the same configuration as that of the header housing 80 in the first connector assembly 1, and hence description thereof is omitted here.

As shown in FIG. 6B, the header base 190 includes a base 191, a mating tube space 193 in which the mating tube 83 is positioned by penetrating therethrough, screw through holes 195 respectively formed in four corners of the base 191, and a pair of locking claws 198 for mutual locking to the header housing 80 on both sides in the longitudinal direction L of the base 191. In addition, as further shown in FIG. 6B, the two screw holes 197 for respectively fixing the base housing 140 with the fixing screws 143 are formed on both sides in the longitudinal direction L with the mating tube space 193 sandwiched therebetween. The header base 190 is configured as a single member by, for example, die-casting an aluminum alloy.

The header base 190 is fixed to a housing of a motor, with the receptacle connector 110 mounted on the header housing 80. This fixing is performed by tightening screws to the housing of the motor after respectively penetrating through the four screw through holes 195. At this time, the mating of the receptacle connector 110 to the header connector 170 is performed between the base housing 140 and the header housing 80, the locking of the receptacle connector 110 to the header connector 170 is performed between the base housing 140 and the header base 190, and the fixing of the second connector assembly 2 to the motor is performed through the header base 190. That is, in the second connector assembly 2, the header connector 170 is divided into two, i.e., the header housing 80 and the header base 190 depending on functions such that the header housing 80 is made to have a function of the mating with the receptacle connector 110 and the header base 190 is made to have a function of the fixing to the motor.

As described above, the header housing 80 is shared between the header connector 70 in the first connector assembly 1 and the header connector 170 in the second connector assembly 2. That is, the seal 89, the header housing 80, and the header base 90 are assembled to constitute the header connector 70, and the seal 89, the header housing 80, and the header base 190 are assembled to constitute the header connector 170.

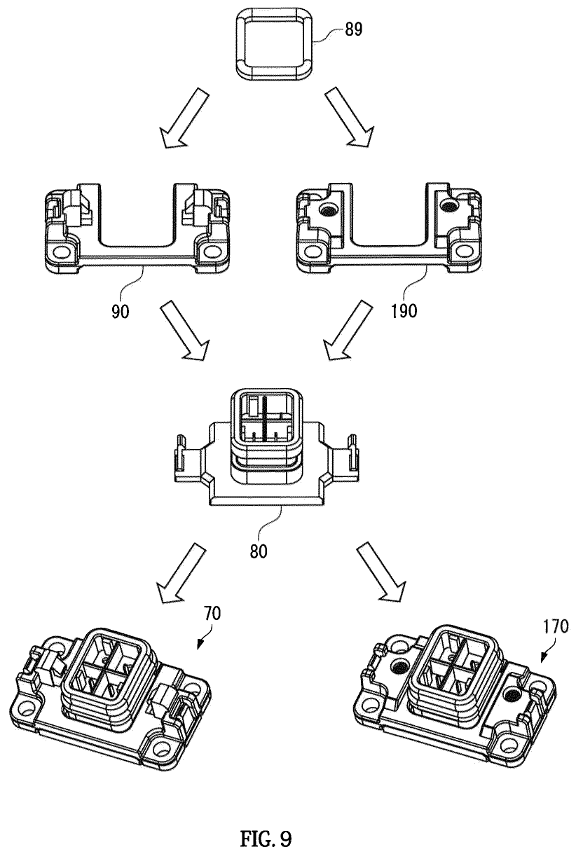

Effects of the first connector assembly 1 and the second connector assembly 2 are now described with reference to FIG. 9.

As described above, the header connectors 70 and 170 are respectively divided into the header housings 80 associated with mating with base housings 40 and 140 in the receptacle connectors 10, 110, and the header bases 90, 190 associated with fixing to the base housings 40 and 140 in the receptacle connectors 10 and 110.

The base housing 40 and the base housing 140 are respectively of different fixing types, i.e., a one-touch type and a screw-tightening type, and the header connectors 70,170 are respectively of different locking types, i.e., a one-touch type and a screw-tightening type. Accordingly, a structure of the header base 90 and a structure of the header base 190 cannot be made common. On the other hand, the header housings 80 are respectively portions associated with the mating with the base housing 40 and the base housing 140, and their respective structures can be made common. Therefore, as shown in FIG. 9, the header housing 80 can be shared while enabling selection of the one-touch type first connector assembly 1 or the screw-tightening type second connector assembly 2 depending on an application. As further shown in FIG. 9, when the header housing 80 is shared, the connector housing 20 to be mated with the mating tube 83 in the header housing 80 and the seal 89 to be mounted on the mating tubes 83 can also be shared between the first connector assembly 1 and the second connector assembly 2. In other words, the header housing 80 including the mating tube 83 can avoid being associated with a locking type, and thus can be shared regardless of a form of a locking type such as a one-touch type or a screw-tightening type.

As shown in FIG. 9, when the one-touch type header base 90 or the screw-tightening type header base 190 is used, the common header housing 80 is applied to both the header bases 90, 190, so that a waterproof property and a mating property between the header housing 80 and the receptacle connector 10 or the receptacle connector 110 can be ensured.

In the seal 89 according to an embodiment, a sealing protrusion as a sealing element is doubled in the mating direction M. Therefore, in addition to an improvement in a waterproof property, loosening of a sealing portion can be limited using a repulsive force of rubber.

In the first connector assembly 1 and the second connector assembly 2, cable pull-out directions of the receptacle connectors 10, 110 can be respectively made perpendicular to the header bases 90, 190.

In addition to the above, components described in the above embodiment can be sorted out and appropriately changed into other components without departing from the spirit of the invention. Although the one-touch type and the screw-tightening type are illustrated as a specific example of the locking type in the embodiment, the present invention is also applicable to other locking types. The other locking types include slide, push, pull, and double-touch types.

1. An electrical connector, comprising:
a housing including a mating tube matable with a mating connector; and
one of a plurality of bases each including a locking element of one of a plurality of different locking types, the one of the plurality of bases is assembled with the housing with the mating tube penetrating through a front and a back of the one of the plurality of bases and protruding from the one of the plurality of bases, the locking element is fixable to the mating connector and the locking element is selectable among the plurality of different locking types to correspond to a fixing type of the mating connector.

2. The electrical connector of claim 1, wherein the fixing to the mating connector is a one-touch type and the locking element is a locking piece locking to the mating connector.

3. The electrical connector of claim 1, wherein the fixing to the mating connector is a screw-tightening type and the locking element is a screw hole engaging with a fixing screw of the mating connector.

4. The electrical connector of claim 1, further comprising a seal fitted on the mating tube.

5. The electrical connector of claim 4, wherein the seal has a single sealing protrusion in a direction of mating of the electrical connector to the mating connector.

6. The electrical connector of claim 4, wherein the seal has a plurality of sealing protrusions in a direction of mating of the electrical connector to the mating connector.

7. The electrical connector of claim 1, wherein the housing includes a housing base supporting the one of the plurality of bases, the mating tube protrudes from the housing base.

8. The electrical connector of claim 7, wherein the housing base is mountable on each of the plurality of bases, and each of the plurality of bases includes a mating tube space receiving the mating tube penetrating through the front and the back.

9. The electrical connector of claim 1, wherein the housing has a plurality of locking protrusions, each of the plurality of bases has a plurality of locking claws engaging the locking protrusions when each of the plurality of bases is assembled with the housing.

10. The electrical connector of claim 1, wherein each of the plurality of bases has a plurality of screw through holes, one of the screw through holes is formed in each corner of each of the plurality of bases.

11. The electrical connector of claim 2, wherein the locking piece has a catch protrusion and a support that extends from the one of the plurality of bases.

12. The electrical connector of claim 11, wherein the catch protrusion is received in a locking hole of a locking member of the mating connector, the catch protrusion locks the mating connector to the electrical connector.

13. The electrical connector of claim 1, wherein each of the plurality of bases is formed as a single member.

14. The electrical connector of claim 1, wherein each of the plurality of bases has a rectangular shape.

15. The electrical connector of claim 1, wherein the mating tube has a cylindrical square shape.

16. An electrical connector assembly, comprising:
a mating connector; and
an electrical connector mated with and fixed to the mating connector, the electrical connector includes a housing and one of a plurality of bases, the housing has a mating tube matable with the mating connector, each of the plurality of bases include a locking element of one of a plurality of different locking types, the one of the plurality of bases is assembled with the housing with the mating tube penetrating through a front and a back of the one of the plurality of bases and protruding from the one of the plurality of bases, the locking element is fixed to the mating connector and the locking element is selectable among the plurality of different locking types to correspond to a fixing type of the mating connector.
